(19) United States
(12) Patent Application Publication
(10) Pub. No.: US 2018/0184266 A1
(43) Pub. Date: Jun. 28, 2018

(54) METHOD AND APPARATUS FOR AUTOMATICALLY ADMINISTERING SHARED MOBILE DEVICES

(71) Applicant: SONIM TECHNOLOGIES, INC., San Mateo, CA (US)

(72) Inventor: Rajesh Doyijode, Bangalore (IN)

(21) Appl. No.: 15/851,196

(22) Filed: Dec. 21, 2017

Related U.S. Application Data
(60) Provisional application No. 62/438,427, filed on Dec. 22, 2016.

(51) Int. Cl. H04W 4/30; H04L 29/08; H04W 4/021; H04W 4/80

(52) U.S. Cl. CPC H04W 4/30; H04L 67/306; H04W 4/80; H04W 4/021; H04L 67/22

(57) ABSTRACT

The embodiments herein provide a method for automatically administrating a mobile device among a plurality of users. The method includes detecting, by an administrative device, a login event to the mobile device by a candidate user from the plurality of users based on at least one login activity, identifying, by the administrative device, the candidate user, and downloading, by the administrative device, a profile associated with the candidate user at the mobile device, wherein the profile comprising application data and configuration associated with the candidate user.

This application claims the benefit of U.S. Provisional Application No. 62/438,427, filed 22nd Dec. 2016.

### FIELD OF INVENTION

The present disclosure relates to administrating mobile devices, and more particularly to methods and an apparatus to automatically administrating a mobile device shared among a plurality of users.

### BACKGROUND

Many industries such as mining, oil and gas, security, construction, utilities and transportation etc. require their employees or workers to pick up a mobile device at the start of a shift and hand it back at the end of the shift. Usually in such cases a single mobile device can be used by multiple workers. This helps employers to reduce the number of mobile devices in use by limiting the number to the number of workers working in a single shift.

Since any mobile device can be picked up by a worker at any time, it becomes imperative that the mobile device, when used by the worker, has a user profile customized for the worker. Application data specific to the worker is displayed or is accessible through the mobile device. When another worker uses the mobile device, the user profile is changed to the user profile of the other worker.

Currently the problem is addressed by having a separate user profile stored locally on the mobile device for each user that the mobile device gets shared with. There are solutions which support multi-user profiles in the sense that only some personalization settings are pushed to the device upon login of the user. However, a full application data backup is unavailable at the end of the shift.

Further, there is no mechanism in which the mobile device, assigned to the worker, populates all the application data pertaining to the worker automatically. Also, there is no mechanism to provide a full data backup of all the data created by the worker on the mobile device upon logout at the end of the shift, and restoring the full data back to the device upon login at the start of the shift.

The above information is presented as background information only to help the reader to understand the present invention. Applicants have made no determination and make no assertion as to whether any of the above might be applicable as Prior Art with regard to the present application.

### SUMMARY

Accordingly, the embodiments herein provide a method for automatically administrating a mobile device among a plurality of candidate users. The method includes receiving, by an administrative device, information indicative of a login event to a mobile device by a candidate user from the plurality of candidate users based on at least one login activity, identifying, by the administrative device, the candidate user, and downloading, by the administrative device, a profile associated with the candidate user at the mobile device, wherein the profile comprising application data and configuration associated with the candidate user.

In an embodiment, the at least one login activity comprises at least one geo-fence information indicating availability of the candidate user in a geographic area, a swipe-in information availability presence of the candidate user, a quick response (QR) code information received from the mobile device, and a near field communication (NFC) tap information received from the mobile device.

In an embodiment, the profile associated with the candidate user is generated by the administrative device upon customization of application data and configuration over a uniform resource link (URL).

In an embodiment, the method further includes monitoring, by the administrative device, actions performed by the candidate user at the mobile device, detecting, by the administrative device, a logout event from the mobile device by the candidate user based on at least one logout activity, uploading, by the administrative device, information about the actions performed by the candidate user at the mobile device, and deleting, by the administrative device, a local information about the actions stored at the mobile device.

In an embodiment, the at least one logout activity comprises at least one geo-fence information indicating availability of the candidate user in a geographic area, a swipe-out information indicating availability of the candidate user, a quick response (QR) code information received from the mobile device, and a near field communication (NFC) tap information received from the mobile device.

In an embodiment, the method includes receiving a request comprising credentials of a candidate user from the plurality of user to access the mobile device. The method further includes comparing the received credentials of the candidate user corresponding to credentials of the candidate user stored at the administrative device. Furthermore, the method includes identifying the candidate user based on the comparison.

Accordingly, the embodiments herein provide an administrative device for automatically administrating a mobile device shared among a plurality of candidate users. The administrative device includes a processor, a memory to store a profile with each of the plurality of users and an administrative controller, coupled to the processor and the memory. The administrative controller is configured to receive information indicative of a login event to the mobile device by a candidate user from the plurality of user based on at least one login activity, identify the candidate user and download a profile associated with the candidate user at the mobile device. The profile comprises application data and configuration associated with the candidate user.

In an embodiment, the administrative device is further configured to monitor actions performed by the candidate user at the mobile device, detect a logout event from the mobile device by the candidate user based on at least one logout activity, upload information about the actions performed by the candidate user at the mobile device and delete a local information about the actions stored at the mobile device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates an environment in which an administrative device and a mobile device are connected through a secure network, according to an embodiment disclosed herein.

FIG. 2 is a block diagram illustrating hardware components of the administrative device, according to an embodiment disclosed herein.

FIG. 3 is a flow diagram illustrating a method for automatically administrating the mobile device, according to an embodiment disclosed herein.

FIG. 4 is a sequence diagram illustrating a method for automatically administrating the mobile device by the administrative device, according to an embodiment disclosed herein.

FIG. 5 is a sequence diagram illustrating a method for automatically administrating a mobile device by the administrative device, in which the administrative device detects a login activity of a candidate user, according to an embodiment disclosed herein.

FIG. 6 is a sequence diagram illustrating a method for automatically administrating a mobile device by the administrative device in which the administrative device detects the candidate user entering a location, according to an embodiment disclosed herein.

FIG. 7 is a sequence diagram illustrating a method for automatically backup a user profile when a user enters a location, according to an embodiment disclosed herein.

FIG. 8 is a sequence diagram illustrating a method for automatically downloading a user profile when a user leaves a location, according to an embodiment disclosed herein.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, engines, controllers, units or modules or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Conventional methods are directed to having a separate user profile stored locally on the mobile device for each user that the mobile device gets shared with. There are solutions which support multi-user profiles in the sense that only some personalization settings are pushed to the device upon login of the user. However, a full application data backup is unavailable at the end of the shift.

Unlike the conventional methods, the proposed method is directed to receiving information indicative of a login event to the mobile device with regard to a candidate user, identifying the candidate user and automatically downloading a user profile associated with the candidate user at the mobile device. Further, a logout event from the mobile device with regard to the candidate user is detected and accordingly, information about the actions performed by the candidate user at the mobile device is automatically backed up to a central server and local information pertaining to the actions of the candidate user is deleted from the mobile device.

The embodiments herein disclose a method for creating dynamic multi-user profiles for shared mobile devices. The method includes authenticating a candidate user logging into the mobile device and automatically downloading all the data created by the candidate user from a backup on a server, allowing the candidate user to start using the mobile device. Further, the method includes providing a backup for the data created by the candidate user at regular intervals to a server so that any mobile device can be populated with the user data, thereby making the user profiles device independent.

Unlike conventional systems and methods, the proposed method does not store the user data locally all through the mobile device life cycle. The proposed method allows the candidate user to login to a new device wherein their applications and data are automatically restored from the server. Candidate users are allowed to login to any device where their applications and application-data are synchronized to the server.

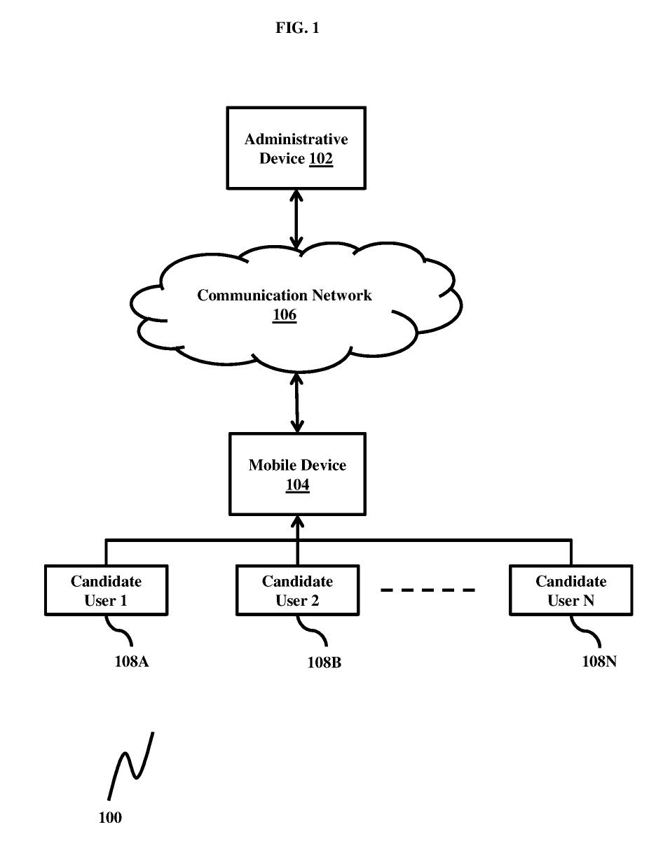

Referring now to the drawings, and more particularly to FIGS. 1 through 8, where similar reference characters denote corresponding features consistently throughout the figures, there are shown preferred embodiments.

FIG. 1 illustrates a network environment 100 in which an administrative device 102 is connected to a mobile device 104 through a communication network 106. The mobile device 104 is shared among a plurality of candidate users 108A to 108N (hereinafter referred to as candidate users 108).

The communication network 106 can include a data network such as, but not restricted to, the Internet, local area network (LAN), wide area network (WAN), metropolitan area network (MAN) etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the communication network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the administrative device 102 and the mobile device 104 with each other.

The mobile device 104 can include any electronic device, such as desktop computers, portable computers, smart phones, tablet computers, wearable devices, and the like. The mobile device 104 and the administrative device 102 can also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

The administrative device 102 includes a non-transitory computer medium that can be configured to receive and transmit communication requests and/or communication responses to and from the mobile device 104. The administrative device 102 can be any or a combination a server, a local computer connected to the communication network 106 or another mobile device connected to the communication network 106. In some embodiments, the administrative device 102 can be connected to a local computer having a database of records pertaining user profiles of the candidate users 108.

In some embodiments, the administrative device 102 monitors activities pertaining to a geo-fence device or a swiping device to detect a login event to the mobile device 104 by a candidate user 108. Login events can also be detected by the administrative device 102 through a quick response (QR) code received from the mobile device 104 or a Near Field Communication (NFC) tap information received from the mobile device 104.

A candidate user 108 logs into the mobile device 104 by any authentication mechanism that can be, but not limited to a fingerprint authentication, voice authentication and use of authentication token or a password. If the authentication is successful, a communication pathway is established between the administrative device 102 and the mobile device 104. Further application data pertaining to the candidate user is downloaded on the mobile device 104 from the application device 102 or from an external database connected to the administrative device 102.

In some embodiments, the administrative device 102 establishes a communication pathway with the mobile device 104 in order to provision the mobile device 104. In an embodiment, the administrative device 102 displays a QR code that contains the configuration information for the mobile device 104 to connect to the administrative device 102 over the communication network 106. The candidate user 108 scans the QR code using the mobile device 104 to setup the mobile device 104 with the configuration data.

In some embodiments, the configuration data is encoded into NFC data and the candidate user taps the mobile device 104 with the administrative device 102 to connect the mobile device 104over the communication network 106. In yet other embodiments, the administrative device 102 and the mobile device 104 can use Google™ nearby application programming interface (API) that allows the administrative device 102 and the mobile device 104 to communicate with each other when in close proximity.

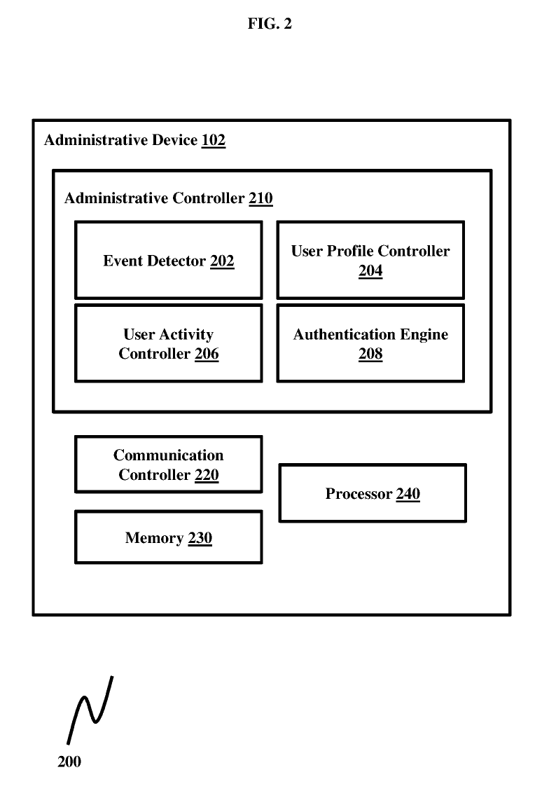

FIG. 2 is a block diagram illustrating hardware components of the administrative device 102. The administrative device 102 includes an administrative controller 210, a communication controller 220, a processor 240 and a memory 230. The administrative controller 210 further includes an event detector 202, a user profile controller 204, a user activity controller 206 and an authentication engine 208.

The processor 240 may be, but not restricted to, a Central Processing Unit (CPU), a microprocessor, or a microcontroller. The processor 240 is coupled to the memory 230 and the administrative controller 210. The processor 240 executes sets of instructions stored on the memory 230.

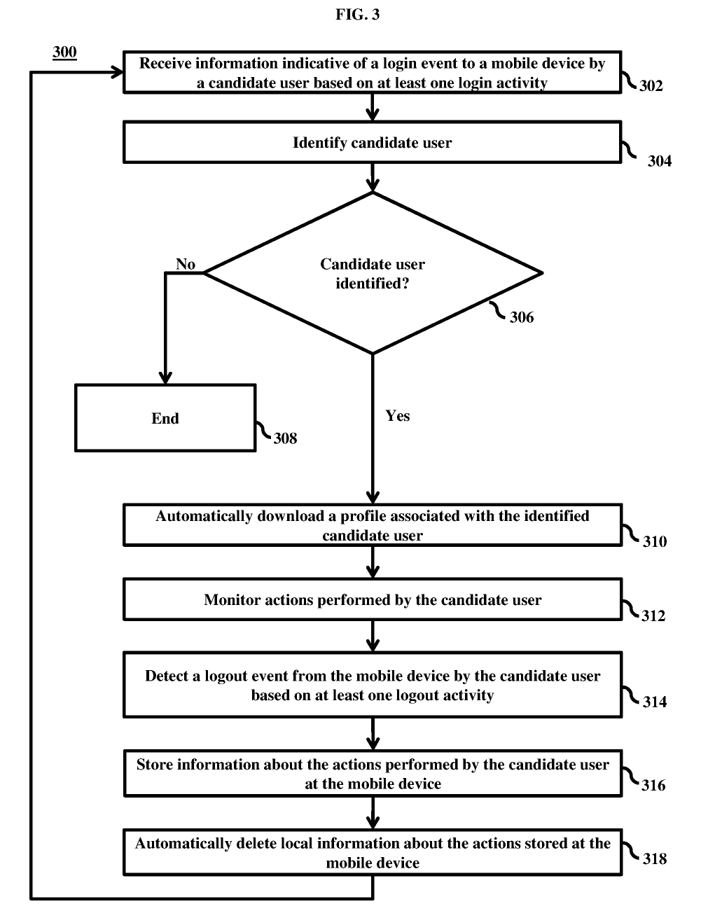

FIG. 3 illustrates a flow diagram illustrating a method 300 for automatically administrating the mobile device 104 by the administrative device 102. At step 302, the event detector 202 (shown in FIG. 2) detects a login event to the mobile device 104 by the candidate user 108 based on a login activity from information received by the administrative device 102 from an authentication device. In some embodiments, the information indicative of login activity is received from a swiping device. In other embodiments, the information indicative of login activity is received from the mobile device 104. In some other embodiments, the information indicative of login activity is received from a geo-location sensor. The login activity can be, but not limited to, providing a password or an authentication token, entering a geo-location and swiping in to a biometric device or a punching machine.

At step 304, the candidate user 108 is identified based on user credentials shared during the login activity. If the user authentication is successful at step 306, a profile associated with the identified candidate user 108 is automatically downloaded to the mobile device 104. If the authentication is unsuccessful, the mobile device 104 is inaccessible to the candidate user 108. The authentication engine 208 determines the identity of the candidate user 108 based on the shared user credentials. Accordingly, the user profile controller 204 maps the identity of the candidate to a profile stored on the memory 230.

The administrative device 102 establishes a communication pathway with the mobile device 104 in order to provision the mobile device 104. In some embodiments, the profile can be a new profile created by the user profile controller 204 (shown in FIG. 2). The new profile includes general application data pertaining to the tasks of the candidate user in the current shift. In other embodiments, the user profile controller 204 transmits a profile to the mobile device 104 where the profile corresponds to data stored on a profile database connected to the administrative device 102. The profile database can be part of the memory 230. The profile is automatically downloaded through the communication network 106 at step 310 in response to identifying the candidate user 108.

At step 312, the user activity controller 206 further monitors actions of the candidate user 108 performed on the mobile device 104. Monitoring includes periodic backing up of new data in the memory 230 or in an external database where the new data is created through the actions performed.

At step 314, the candidate user may choose to logout on account of ending of a work shift. Accordingly, the event detector 202 detects a logout event. In some embodiments, the candidate user may leave a geographic area and corresponding geo-fence information is received at the communication controller 220 of the administrative device 102. Accordingly, based on the geo-fence information, the event detector 202 detects that the candidate user 108 is unavailable and automatically uploads information regarding the actions performed by the candidate user 108 at the mobile device 104 to the memory 230 or to an external database through the communication network 106.

In some embodiments, the event detector 202 detects a swipe-out action performed by the candidate user 108 at a swiping device such as a biometric device or a punching device, connected to the communication network 106. In other embodiments, the candidate user 108 performs a log-out action at the mobile device 104 and accordingly, information pertaining to the log-out action is transmitted to the communication controller 220 and the event detector 202. At step 316, upon detection of the log-out event, information regarding the monitored actions of the candidate user 108 is backed up to the memory 230 or any other external database or memory connected to the administrative device 102.

At step 318, any local information about the action stored at the mobile device 104 is deleted by the user profile controller 204 remotely through the communication network 106.

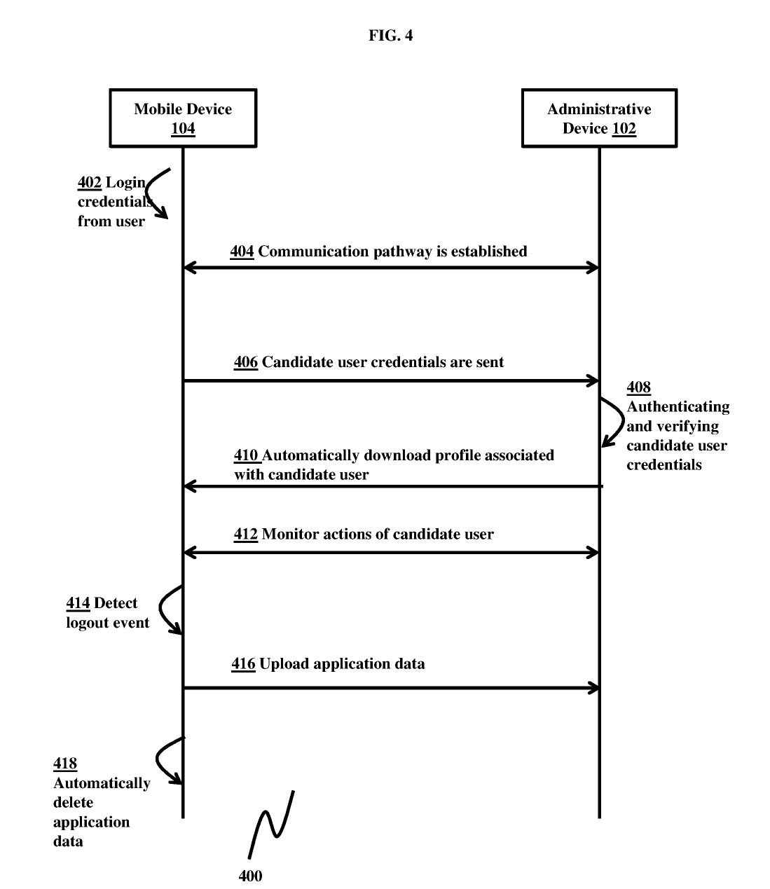

FIG. 4 is a sequence diagram illustrating a method 400 for automatically administrating the mobile device 104 by the administrative device 102. At step 402, the mobile device 104 receives login information from the end-user. In some embodiments, the login event can comprise a swiping action at a biometric device or a punching machine. The candidate user begins a shift by swiping in at an entry device. The entry device can be a biometric device where the candidate user provides his/her fingerprints to be authenticated. Further iris scans can also be performed for authentication.

In some embodiments, the presence of the candidate user 108 is detected in a geographic area that is bound by a virtual geographic boundary. The virtual geographic boundary is defined by pre-defined set of boundaries, the Global Positioning System (GPS) or Radio Frequency Identity (RFID) technology, enabling the event detector 202 to detect the event when the candidate user 108 or the mobile device 104 enters or leaves the geographic area.

At step 404, the event detector 202 (shown in FIG. 2) detects a login event to the mobile device 104 by the candidate user 108 through a communication pathway established between the mobile device 104 and the administrative device 102. In an embodiment, the administrative device 102 displays a QR code that contains the configuration information for the mobile device 104 to connect to the administrative device over the communication network 106. The candidate user 108 scans the QR code using the mobile device 104 to setup the mobile device 104 with the configuration data.

In some embodiments, the configuration data is encoded into NFC data and the candidate user taps the mobile device 104 with the administrative device 102 to connect the mobile device 104 over the communication network 106. In yet other embodiments, the administrative device 102 and the mobile device 104 can use the Google™ nearby application programming interface (API) that allows the administrative device 102 and the mobile device 104 to communicate with each other when in close proximity.

At step 408, the candidate user 108 is identified based on user credentials transmitted to the administrative device 102. The authentication engine 208 determines the identity of the candidate user 108 based on the shared user credentials. Accordingly, the user profile controller 204 maps the identity of the candidate to the profile stored on the memory 230.

The administrative device 102 establishes a communication pathway with the mobile device 104 in order to provision the mobile device 104. In some embodiments, the profile can be a new profile created by the user profile controller 204 (shown in FIG. 2). The new profile includes general application data pertaining to the tasks of the candidate user in the current shift. The profile is automatically downloaded through the communication network 106 at step 410 in response to identifying the candidate user 108.

At step 412, the user activity controller 206 further monitors actions of the candidate user 108 performed on the mobile device 104. Monitoring includes periodic backing up of new data in the memory 230 or in an external database where the new data is created through the actions performed.

At step 414, the candidate user 108 may choose to logout on account of ending of a work shift. Accordingly, the event detector 202 detects a logout event based on information transmitted through the communication pathway. In some embodiments, the candidate user 108 may leave a geographic area and corresponding geo-fence information is received at the communication controller 220 of the administrative device 102. Accordingly, based on the geo-fence information, the event detector 202 detects that the candidate user 108 is unavailable and automatically uploads information regarding the actions performed by the candidate user 108 at the mobile device 104 to the memory 230 or to an external database through the communication network 106. In some embodiments, the event detector 202 detects a swipe-out action performed by the candidate user 108 at a swiping device such as a biometric device or a punching device, connected to the communication network 106. In other embodiments, the candidate user 108 performs a log-out action at the mobile device 104. Accordingly, information pertaining to the log-out action is transmitted to the communication controller 220 and the event detector 202. At step 416, upon detection of the log-out event, information regarding the monitored actions of the candidate user 108 is backed up to the memory 230 or any other external database or memory connected to the administrative device 102.

At step 418, any local information about the action stored at the mobile device 104 is deleted by the user profile controller 204 remotely through the communication network 106.

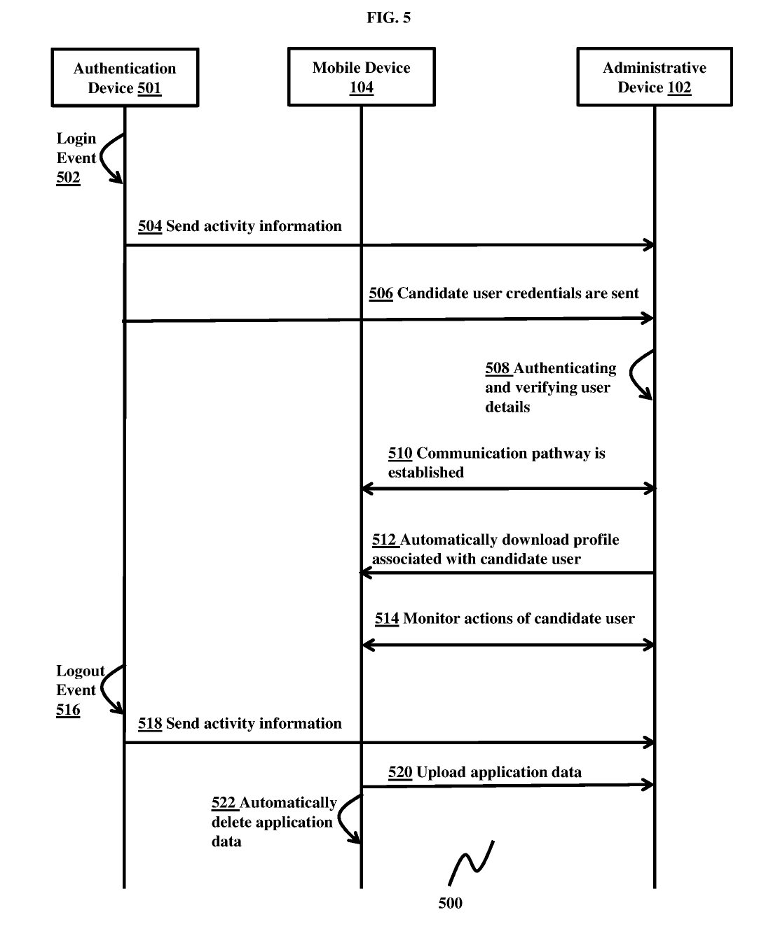

FIG. 5 is a sequence diagram illustrating a method 500 for automatically administrating the mobile device 104 by the administrative device 102. At step 502, the candidate user 108 provides credentials at an authentication device 501. The candidate user 108 begins a shift by swiping in at the authentication device 501. The authentication device 501 can be a fingerprint authentication device where the candidate user provides his/her fingerprints to be authenticated or an iris scanner where iris scans of the candidate user 108 can also be performed for authentication. In some embodiments, the authentication device 501 can also be a punching machine that transmits a signal to the administrative device 102 based on a swiping action performed by the candidate user 108. At step 504, activity information pertaining to the login activity is transmitted from the authentication device 501 to the administrative device 102. The event detector 202 (shown in FIG. 2) detects the login event and provides the candidate user 108 with access to the mobile device 104.

In some embodiments, the authentication device 501 and the mobile device 104 is the same. The candidate user 108 provides authentication information such as biometrics or an authentication token at the mobile device 104. Accordingly, the login activity is detected by the event detector 202.

At step 506, the candidate user 108 is identified based on user credentials transmitted to the administrative device 102. At step 508, the authentication engine 208 determines the identity of the candidate user 108 based on the shared user credentials. Accordingly, the user profile controller 204 maps the identity of the candidate to the profile stored on the memory 230.

At step 510, the administrative device 102 establishes a communication pathway with the mobile device 104 in order to provision the mobile device 104. In an embodiment, the administrative device 102 displays a QR code that contains the configuration information for the mobile device 104 to connect to the administrative device 102 over the communication network 106. The candidate user 108 scans the QR code using the mobile device 104 to setup the mobile device 104 with the configuration data.

In some embodiments, the configuration data is encoded into NFC data and the candidate user taps the mobile device 104 with the administrative device 102 to connect the mobile device over the communication network 106. In yet other embodiments, the administrative device 102 and the mobile device 104 can use the Google™ nearby application programming interface (API) that allows the administrative device 102 and the mobile device 104 to communicate with each other when in close proximity.

The administrative device 102 establishes a communication pathway with the mobile device 104 in order to provision the mobile device 104. In some embodiments, the profile can be a new profile created by the user profile controller 204 (shown in FIG. 2). The new profile includes general application data pertaining to the tasks of the candidate user in the current shift. The profile is automatically downloaded through the communication network 106 at step 512 in response to identifying the candidate user 108.

At step 514, the user activity controller 206 further monitors actions of the candidate user 108 performed on the mobile device 104. Monitoring includes periodic backing up of new data in the memory 230 or in an external database where the new data is created through the actions performed.

At step 516, the candidate user 108 may choose to logout on account of ending of a work shift. Accordingly, at step 518 the event detector 202 detects a logout event based on activity information transmitted. The event detector 202 detects a swipe-out action performed by the candidate user 108 at the authentication device 501. In other embodiments, the candidate user 108 performs a log-out action at the mobile device 104. Accordingly, information pertaining to the log-out action is transmitted to the communication controller 220 and the event detector 202.

At step 520, upon detection of the log-out event, information regarding the monitored actions of the candidate user 108 is backed up to the memory 230 or any other external database or memory connected to the administrative device 102.

At step 522, any local information about the action stored at the mobile device 104 is deleted by the user profile controller 204 remotely through the communication network 106.

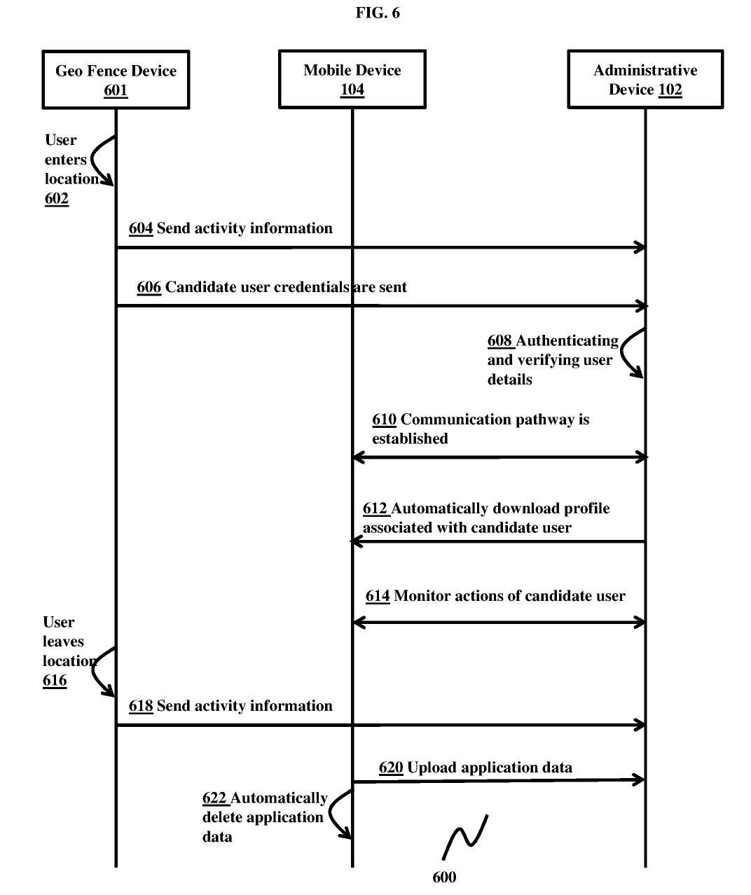

FIG. 6 is a sequence diagram illustrating a method 600 for automatically administrating the mobile device 104 by the administrative device 102 in which the administrative device 102 detects the candidate user 108 entering a location. At step 602, the candidate user enters a geographic area. The event detector 202 (shown in FIG. 2) detects a login event to the mobile device 104 by the candidate user 108 based on detection of the candidate user 108 in a geographic area. The geographic area is bound by a virtual geographic boundary defined by pre-defined set of boundaries, the Global Positioning System (GPS) or Radio Frequency Identity (RFID) technology enabling the event detector 202 to detect the event when the candidate user 108 or the mobile device 104 enters or leaves the geographic area. The presence of the candidate user 108 or the mobile device 104 in the geographic area is detected by a geo-fence device 601, which in turn sends the corresponding detection information to the administrative device 102 through the communication network 106 (step 604).

At step 606, the candidate user 108 is identified based on user credentials transmitted to the administrative device 102. At step 608, the authentication engine 208 determines the identity of the candidate user 108 based on the shared user credentials. Accordingly, the user profile controller 204 maps the identity of the candidate to the profile stored on the memory 230.

At step 610, the administrative device 102 establishes a communication pathway with the mobile device 104 in order to provision the mobile device 104. In an embodiment, the administrative device 102 displays a QR code that contains the configuration information for the mobile device 104 to connect to the administrative device 102 over the communication network 106. The candidate user 108 scans the QR code using the mobile device 104 to setup the mobile device 104 with the configuration data.

In some embodiments, the configuration data is encoded into NFC data and the candidate user taps the mobile device 104 with the administrative device 102 to connect the mobile device over the communication network 106. In yet other embodiments, the administrative device 102 and the mobile device 104 can use the Google™ nearby application programming interface (API) that allows the administrative device 102 and the mobile device 104 to communicate with each other when in close proximity.

The administrative device 102 establishes a communication pathway with the mobile device 104 in order to provision the mobile device 104. In some embodiments, the profile can be a new profile created by the user profile controller 204 (shown in FIG. 2). The new profile includes general application data pertaining to the tasks of the candidate user in the current shift. At step 612, the profile is automatically downloaded through the communication network 106 at step 410 in response to identifying the candidate user 108.

At step 614, the user activity controller 206 further monitors actions of the candidate user 108 performed on the mobile device 102. Monitoring includes periodic backing up of new data in the memory 230 or in an external database where the new data is created through the actions performed.

At step 616, the candidate user 108 may choose to logout on account of ending of a work shift. Accordingly, the event detector 202 detects a logout event. The candidate user 108 may leave a geographic area and at step 618 the corresponding geo-fence information is received at the communication controller 220 of the administrative device 102. Accordingly, based on the geo-fence information, the event detector 202 detects that the candidate user 108 is unavailable and at step 620 the mobile device 104 automatically uploads information regarding the actions performed by the candidate user 108 at the mobile device 104 to the memory 230 or to an external database through the communication network 106.

At step 622, any local information about the action stored at the mobile device 104 is deleted by the user profile controller 204 remotely through the communication network 106.

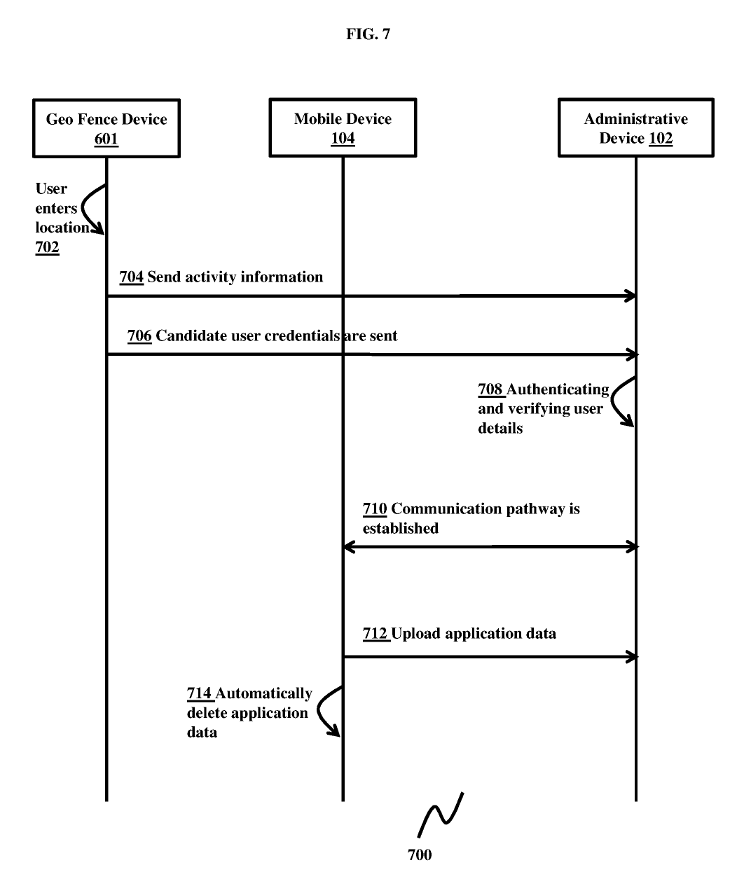

FIG. 7 is a sequence diagram illustrating a method 700 for automatically administrating the mobile device 104 by the administrative device 102 in which the administrative device 102 detects the candidate user 108 entering a location. At step 702, the candidate user enters a geographic area. The geographic area can be an area around the exit of a workplace or a building. The presence of the candidate user 108 or the mobile device 104 in the geographic area is detected by a geo-fence device 601, which in turn sends the corresponding detection information to the administrative device 102 through the communication network 106 (Step 704). At step 706, the candidate user 108 is identified based on user credentials transmitted to the administrative device 102.

At step 708, the authentication engine 208 determines the identity of the candidate user 108 based on the shared user credentials. Accordingly, the user profile controller 204 maps the identity of the candidate to the profile stored on the memory 230. At step 710, the administrative device 102 establishes a communication pathway with the mobile device 104. Based on the geo-fence information, the event detector 202 detects that the candidate user 108 has entered a geographic area that is indicative of the candidate user 108 leaving the workplace. At step 712 the mobile device 104 automatically uploads information regarding the actions performed by the candidate user 108 at the mobile device 104 to the memory 230 or to an external database through the communication network 106.

At step 714, any local information about the action stored at the mobile device 104 is deleted by the user profile controller 204 remotely through the communication network 106.

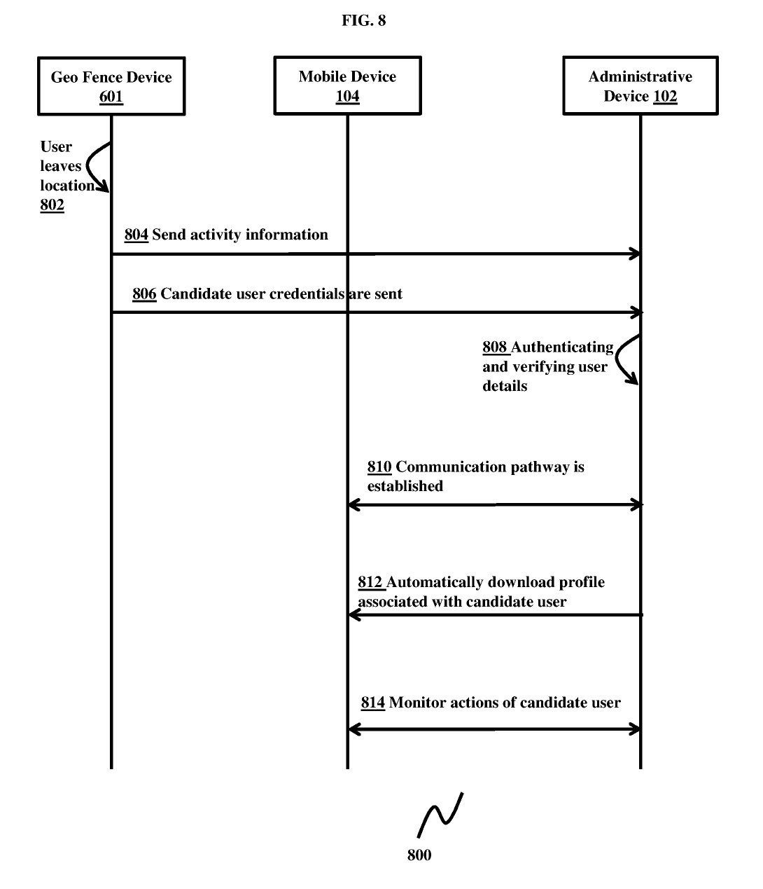

FIG. 8 is a sequence diagram illustrating a method 800 for automatically administrating the mobile device 104 by the administrative device 102 in which the administrative device 102 detects the candidate user 108 leaving a location. At step 802, the candidate user leaves a geographic area. The geographic area can be an area around the exit of a workplace or a building. The action of leaving by the candidate user 108 is detected by the geo fence device 601, which in turn sends the corresponding information to the administrative device 102 through the communication network 106 (Step 804). At step 806, the candidate user 108 is identified based on user credentials transmitted to the administrative device 102.

At step 808, the authentication engine 208 determines the identity of the candidate user 108 based on the shared user credentials. Accordingly, the user profile controller 204 maps the identity of the candidate to the profile stored on the memory 230. At step 810, the administrative device 102 establishes a communication pathway with the mobile device 104.

The administrative device 102 establishes a communication pathway with the mobile device 104 in order to provision the mobile device 104. In some embodiments, the profile can be a new profile created by the user profile controller 204 (shown in FIG. 2). The new profile includes general application data pertaining to the tasks of the candidate user in the current shift. At step 812, the profile is automatically downloaded through the communication network 106 at step 410 in response to identifying the candidate user 108.

At step 814, the user activity controller 206 further monitors actions of the candidate user 108 performed on the mobile device 102. Monitoring includes periodic backing up of new data in the memory 230 or in an external database where the new data is created through the actions performed.

The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for automatically administrating a mobile device shared among a plurality of candidate users, comprising:
receiving, by an administrative device, information indicative of a login event to a mobile device by a candidate user from the plurality of candidate users based on at least one login activity;
identifying, by the administrative device, the candidate user; and
downloading, by the administrative device, a profile associated with the candidate user at the mobile device, wherein the profile comprises application data and configuration associated with the candidate user.

2. The method of claim 1, wherein the at least one login activity comprises at least one geo-fence information indicating availability of the candidate user in a geographic area, a swipe-in information availability presence of the candidate user, a quick response (QR) code information received from the mobile device, and a near field communication (NFC) tap information received from the mobile device.

3. The method of claim 1, wherein the profile associated with the candidate user is generated by the administrative device upon customization of application data and configuration over a uniform resource link (URL).

4. The method of claim 1, further comprising:
monitoring, by the administrative device, actions performed by the candidate user at the mobile device;
detecting, by the administrative device, a logout event from the mobile device by the candidate user based on at least one logout activity;
uploading, by the administrative device, information about the actions performed by the candidate user at the mobile device; and
deleting, by the administrative device, a local information about the actions stored at the mobile device.

5. The method of claim 4, wherein the at least one logout activity comprises at least one geo-fence information indicating availability of the candidate user in a geographic area, a swipe-out information indicating availability of the candidate user, a quick response (QR) code information received from the mobile device, and a near field communication (NFC) tap information received from the mobile device.

6. The method of claim 1, wherein the identifying, by the administrative device, the candidate user comprises:
receiving a request comprising credentials of a candidate user from the plurality of user to access the mobile device;
comparing the received credentials of the candidate user corresponding to credentials of the candidate user stored at the administrative device; and
identifying the candidate user based on the comparison.

7. An administrative device for automatically administrating a mobile device shared among a plurality of candidate users, comprising:
a processor;
a memory to store a profile associated with each of the candidate users; and
an administrative controller, coupled to the processor and the memory, configured to:
receive information indicative of a login event to the mobile device by a candidate user from the plurality of candidate users based on at least one login activity,
identify the candidate user, and
download a profile associated with the candidate user at the mobile device, wherein the profile comprises application data and configuration associated with the candidate user.

8. The administrative device of claim 7, wherein the at least one login activity comprises at least one geo-fence information indicating availability of the candidate user in a geographic area, a swipe-in information availability presence of the candidate user, a QR code information received from the mobile device, and an NFC tap information received from the mobile device.

9. The administrative device of claim 7, wherein the profile associated with the candidate user is generated upon customization of application data and configuration over a uniform resource link (URL).

10. The administrative device of claim 7, wherein the administrative controller is further configured to:
monitor actions performed by the candidate user at the mobile device,
detect a logout event from the mobile device by the candidate user based on at least one logout activity,
upload information about the actions performed by the candidate user at the mobile device,
delete a local information about the actions stored at the mobile device.

11. The administrative device of claim 10, wherein the at least one logout activity comprises at least one geo-fence information indicating availability of the candidate user in a geographic area, a swipe-out information indicating availability of the candidate user, a QR code information received from the mobile device, and a NFC tap information received from the mobile device.

12. The administrative device of claim 7, wherein the identify the candidate user comprises:
receive a request comprising credentials of a candidate user from the plurality of user to access the mobile device,
compare the received credentials of the candidate user corresponding to credentials of the candidate user stored at the administrative device, and
identify the candidate user based on the comparison.
